(19) United States
(12) Patent Application Publication
(10) Pub. No.: US 2004/0165481 A1
(43) Pub. Date: Aug. 26, 2004

(54) Radio with a visual and auditory personality that can be programmed to record future broadcasts

(76) Inventor: Ismail Ibric, Pleasant Valley, NY (US)

Correspondence Address: Ismail Ibric, 87 Downing Rd., Pleasant Valley, NY, 12569, US

(21) Appl. No.: 10/783,501

(22) Filed: Feb. 20, 2004

Related U.S. Application Data
(60) Provisional application No. 60/449,005, filed on Feb. 24, 2003.

(51) Int. Cl. H04B 1/20

(52) U.S. Cl. 369/6

(57) ABSTRACT

A method of recording upcoming radio broadcasts to a digital storage device. Recordings can be played back when most convenient for the listener. The embodiments my invention can implement may vary and is not limited to table top radios (depicted in included drawings), entertainment system radios, car stereo radios, portable radios, or any other radio devices.

### CROSS-REFERENCE TO RELATED APPLICATIONS

This application claims the benefits of PPA Ser. Nr. 60/449005

### FEDERALLY SPONSORED REASERCH

Not Applicable

### SEQUENCE LISTING OR PROGRAM

Not Applicable

### BACKGROUND OF THE INVENTION-FIELD OF INVENTION

This invention relates to a method for recording upcoming radio shows much like a VCR does for TV shows.

### BACKGROUND OF THE INVENTION

Many radios on the store shelves have the ability to record live broadcasts. After searching for a radio that could record my upcoming shows, I was left with disappointment that a radio with such a feature did not exist.

The problem has not been approached previously. There are no previous methods to accomplish this. Although there are radios on the market that will let you record a live broadcast with you starting the recording process manually, not one has a way to record an upcoming radio show automatically.

### BACKGROUND OF INVENTION-OBJECTS AND ADVANTAGES

The advantage my invention has over other radios is that it can record upcoming radio shows. Advantages of the present invention are:

a) By setting it to record and upcoming radio show, there is no need to manually start the recording process;

b) Radio shows can be recorded automatically without the need for the person to physically be there to start the recording process.

Further advantages of my invention will become apparent from a consideration of the ensuing description.

### SUMMARY

In accordance with the present invention a method to record upcoming shows from any broadcast delivery methods available, including digital wireless networks.

### DRAWINGS—FIGURES

FIG. 1 is a front view of the preferred embodiment.

FIG. 2 is a top view of the preferred embodiment.

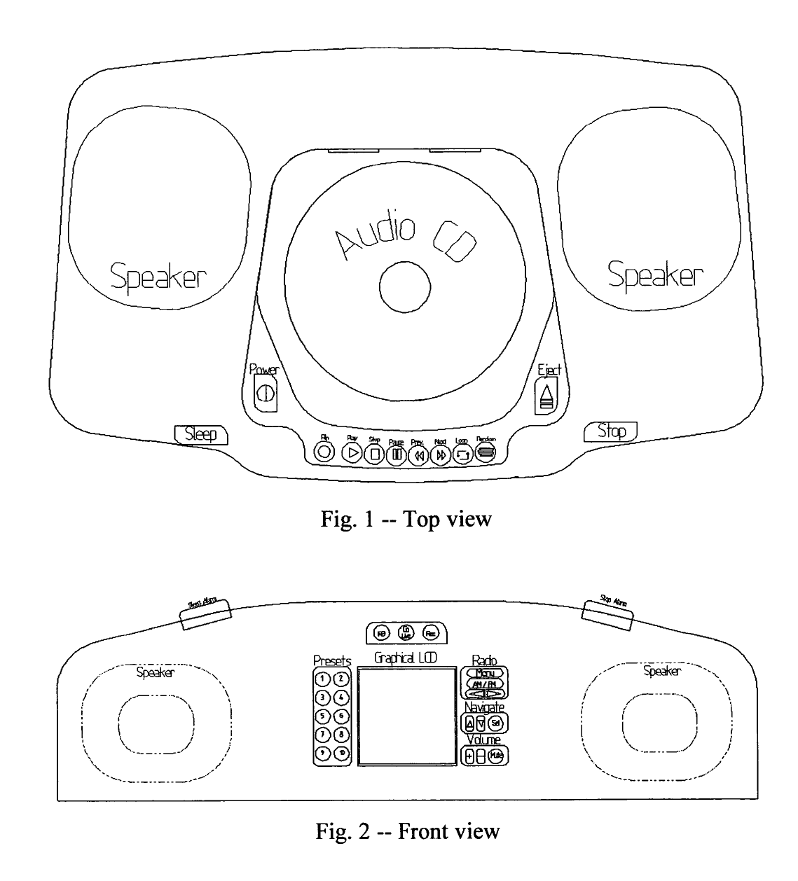

### DETAILED DESCRIPTION—FIGS. 1 AND 2—PREFERRED EMBODIMENT

An example embodiment of the closure of the present invention is illustrated in FIG. 1 (front view) and FIG. 2 (top view). The closure is but an aid to illustrate the kind of devices my invention can be applied to.

Conclusion, Ramifications, and Scope

Although the description above contains specificities, these should not be construed as limiting the scope of the invention but as merely providing illustrations of the presently preferred embodiment of this invention. For example, the closure can have other shapes, such as a rectangular box, oval sphere, etc.; the invention can have a car stereo enclosure; the invention can have a multitude of enclosure; etc.

Thus the scope of the invention should be determined by the appended claims and their legal equivalents, rather than by the examples given.

I claim:

1. A method of recording upcoming radio shows, comprising:
(a) a tuner for capturing radio broadcasts,
(b) a digital storage device for saving captured radio broadcasts,
(c) means for programming said tuner to record upcoming radio broadcasts to said storage device.
